(19) United States
(12) Patent Application Publication
(10) Pub. No.: US 2019/0108763 A1
(43) Pub. Date: Apr. 11, 2019

(54) SYSTEM AND METHOD FOR NAVIGATING AN AIRCRAFT IN A HANGAR

(71) Applicant: Airbus Operations GmbH, Hamburg (DE)

(72) Inventors: Rolf Bense, Jork (DE); Daniel Lahidjanian, Hamburg (DE); Misha Kappelhoff, Jork (DE)

(21) Appl. No.: 16/138,377

(22) Filed: Sep. 21, 2018

(30) Foreign Application Priority Data
Oct. 6, 2017 (DE) 10 2017 123 198.6

(51) Int. Cl. G08G 5/04; G08G 5/00; G01S 17/08; G01S 17/93

(52) U.S. Cl. CPC G08G 5/045; G01S 17/933; G01S 17/08; G08G 5/0078

(57) ABSTRACT

A system for navigating an aircraft in a hangar, having at least one optical sensor firmly connected to the aircraft, wherein the sensor can be used to continuously capture surroundings contour data relative to the aircraft, and having a data processing apparatus, connected to the sensor, that has a data memory storing reference data, wherein the data processing apparatus can be used to detect an aircraft collision risk by continuously matching captured surroundings contour data with the reference data. Also, methods of navigating an aircraft in a hangar.

### CROSS-REFERENCES TO RELATED APPLICATIONS

This application claims the benefit of the German patent application No. 10 2017 123 198.6 filed on Oct. 6, 2017, the entire disclosure of which is incorporated herein by way of reference.

### FIELD OF THE INVENTION

The invention relates to a system and method for navigating an aircraft in a hangar.

### BACKGROUND TO THE INVENTION

Aircraft are removed from ongoing operation and towed into hangars in order to perform maintenance measures or repair measures, for example. The applicable measures can normally be performed more easily in the hangar interior, since the hangar interior is protected from external weather influences to the greatest possible extent. Besides the case described above, almost completely finished aircrafts are also maneuvered, for example for the purpose of performing painting work at the end of an aircraft manufacturing process, into painting hangars provided for this purpose.

In both situations described by way of example, maneuvering of the aircraft as a general rule comprises taxiing the aircraft out of the hangar. In order avoid collisions during this process, which can result in high subsequent costs, (damage to the structure, flight cancellation, etc.), safe navigation in the sense of safe and collision-free movement of the aircraft in the hangar interior is desirable.

Conventionally, aircrafts are taxied into and out of the hangar using manually controlled towing vehicles, and several workers monitor the taxiing processes visually. To ensure safe navigation of this kind, it is normally necessary for several people to monitor the process, since one person alone typically cannot see all areas at the same time.

It is the object of the invention to allow safe and collision-free navigation of an aircraft when moving the aircraft in a hangar, in particular when taking the aircraft into or out of the hangar.

### SUMMARY OF THE INVENTION

An object of the invention is achieved by a system for navigating an aircraft in a hangar, having at least one optical sensor firmly connected to the aircraft, wherein the sensor can be used to continuously capture surroundings contour data relative to the aircraft, and having a data processing apparatus, connected (for data communication purposes) to the sensor, that has a data memory storing reference data, wherein the data processing apparatus can be used to detect an aircraft collision risk by continuously matching captured surroundings contour data with the reference data. The system according to the invention advantageously allows safe navigation in the interior of the hangar. In this case, potential crashes and the accompanying damage are avoided. The system according to the invention can in this case assist automated navigation of the aircraft in the hangar. The system according to the invention can advantageously detect the risk of a collision between the aircraft and items present in the aircraft surroundings, and therefore avoid a collision.

According to the invention, the sensor is connected to the data processing apparatus such that data communication between sensor and data processing apparatus is possible. In other words: data signals can be interchanged between sensor and the data processing apparatus. By way of example, the data processing apparatus is fitted to the aircraft and electrically conductively connected to the sensor(s) via data cable.

According to the invention, the surroundings contour data are captured in 360° surroundings of the aircraft. Typical ranges of the surroundings contour data capture in this case are up to approximately 80 meters. According to the invention, the surroundings contour can be captured in polar coordinates. The surroundings contour data are captured continuously, i.e. at repeated times or at successive intervals of time, according to the invention.

A preferred embodiment of the system is characterized in that the surroundings contour data capturable are hangar interior contour data, and in that the stored reference data are hangar interior contour reference data, wherein matching thereof allows an actual position of the sensor relative to the hangar interior contour to be determined, and wherein comparing the determined actual position with sensor target positions by means of the data processing apparatus allows an aircraft-hangar collision risk to be detected. The system according to this embodiment can detect a collision risk between the aircraft and the hangar. Accordingly, the aircraft can be safely moved or navigated in the interior of the hangar without an unintended collision with the hangar occurring. In particular while the aircraft is being moved into or out of the hangar, the system according to the invention allows safe and collision-free navigation.

The sensor target positions are typically likewise stored in the data memory of the data processing apparatus. Typically, the sensor target positions are positions of the sensor and, indirectly, also of the aircraft at which no collisions can take place on the basis of the previously known aircraft geometry and the previously known hangar interior geometry or hangar interior contour. The hangar interior contour reference data are interior contour data of the hangar that are previously known or predefined (and are available e.g. in stored form in the data processing apparatus). Since the sensor is firmly connected to the aircraft and therefore its relative position in relation to the aircraft always remains unchanged, an actual position (and also the actual orientation) of the whole aircraft is indirectly also known whenever an actual position of the sensor has been determined or is known. The sensor target positions at which no hangar collision is possible on the basis of the known hangar interior contour and the known aircraft (exterior) geometry or the known aircraft (exterior) contour are likewise previously known and are available in stored form (for example in the data memory of the data processing apparatus). The “aircraft-hangar collision risk” event occurs when the determined actual position of the sensor approaches sensor positions at which a collision is indicated up to a stipulated tolerance value or threshold value. If such a tolerance value is exceeded, it is possible for a warning signal to be output, for example, so that further movement of the aircraft can be immediately stopped and a collision can be prevented. One such conceivable warning signal is visual and/or audible signals, for example. Preferably, reflectors may be arranged along the hangar interior contour. This advantageously increases the accuracy when capturing the hangar interior contour or the surroundings contour data, and therefore the accuracy of the actual position of the sensor.

A likewise preferred alternative embodiment of the system is characterized in that the surroundings contour data capturable are space contour data of the aircraft surroundings, and in that the stored reference data are contour data of a virtual protection zone surrounding the aircraft, wherein an aircraft-object collision risk is detected if the matching reveals that at least some of the captured space contour data are inside the virtual aircraft protection zone. That is to say that the system according to this embodiment can be used to detect a collision risk between aircraft and an object that is in the immediate surroundings of the aircraft in an unforeseen manner (more precisely: in a virtual aircraft protection zone). The system allows the aircraft to be safely moved or navigated in the interior of the hangar without an unintended collision with an object that is possibly still in the hangar (for example a motor vehicle left therein or the like) occurring. The aircraft protection zone contour data are contour data of an aircraft protection zone that are previously known or predefined (and are available e.g. in stored form in the data memory of the data processing apparatus). The aircraft protection zone may be an area surrounding the exterior contour of the aircraft in all three spatial directions by a stipulated distance.

The “aircraft-object collision risk” event occurs when the matching reveals that at least some of the captured space contour data are inside the aircraft protection zone. In that case, a warning signal can be output, for example, so that further movement of the aircraft can be immediately stopped and a collision with the object can be prevented. One such conceivable warning signal is visual and/or audible signals, for example.

Further, an embodiment of the system is preferred in which the optical sensor is arranged on the nose gear of the aircraft such that in the extended state of the nose gear the sensor can see a monitoring area that comprises at least two lateral aircraft areas and a front aircraft area. In this manner, primarily that area of the aircraft surroundings that is of particular importance for any aircraft collisions on the basis of the most frequently occurring direction of movement is captured. The two lateral aircraft areas typically comprise all of the areas around the two wings. The front aircraft area typically comprises the whole front fuselage area and an area adjoining that in the direction of forward flight.

Preferably, the system comprises at least one further optical sensor that can continuously capture additional surroundings contour data and that is connected to the data processing apparatus. The additional capture of surroundings contour data improves the detection of a collision risk (for example increases the accuracy thereof) and/or its geometrically capturable area can be enlarged (for example this can also allow surroundings contour data capture in the reverse direction of the aircraft). Further, the one or more optical sensors can be arranged at different levels of the aircraft such that surroundings contour data are captured in all areas surrounding the aircraft.

Preferably, the optical sensor(s) are configured as optoelectronic sensors, in particular the sensor(s) are configured as two-dimensional laser scanners. An optoelectronic sensor or a two-dimensional laser scanner is able, for example by means of rotation of a laser scanning beam within a two-dimensional plane and reception of reflections of a scanning beam (i.e. reflections from items intersecting this two-dimensional plane), to produce a two-dimensional geometry of the captured 360° surroundings as surroundings contour data (e.g. of the interior of an aircraft hangar, that is to say what are known as hangar interior contour data, or from objects in the extremely close surroundings of the aircraft, that is to say what are known as space contour data of the aircraft surroundings). The reflections produced by the rotating scanning beam can be received again by the optoelectronic sensor re laser scanner, the distance of the reflecting items being able to be captured as surroundings contour data in polar coordinates from the propagation time. The optoelectronic sensor(s) or two-dimensional laser scanner(s) may fundamentally be battery operated, the battery either being able to be provided individually on the respective sensor or being able to be fitted to the aircraft. Further, it is alternatively conceivable for the sensors to be connected to the aircraft's electrical system in order to supply the sensors with electric power.

In a particularly preferred embodiment, the aircraft is provided with at least one coupling device that can be used to detachably connect the optical sensor(s) to the aircraft. The optical sensor is therefore able to be used in a navigation position connected to the aircraft in rotationally fixed manner (i.e., in nonrotational manner). Further, the sensor can be detached or removed from the aircraft again after hangar navigation. In order to ensure that the sensor(s) connected to the coupling device in rotationally fixed manner have a correct relative position in relation to the remainder of the aircraft, the sensors can each capture the aircraft geometry surrounding them and match the captured aircraft geometry with a target aircraft geometry in order to check whether they are correctly oriented or whether they have possibly been used incorrectly (with an unwanted orientation relative to the aircraft). In the latter case, an applicable warning tone can be output, so that correct use can take place subsequently.

In a preferred development of the preceding embodiment, the data processing apparatus is fitted in a hangar and the data processing apparatus and the optical sensor(s) have a transmission and reception device for sending and receiving surroundings contour data and reference data. In this manner, the data processing apparatus may advantageously be arranged separately from the aircraft and can communicate with the sensor(s) via the transmission and reception devices. There is therefore no need for provision of the data processing apparatus on the aircraft, this advantageously being linked to a corresponding weight saving. The data processing apparatus can communicate with the sensor(s) by means of a WLAN (wireless local area network), for example.

The object may be likewise achieved by a method for navigating an aircraft in a hangar, having the method steps of: continuously capturing hangar interior contour data relative to the aircraft as surroundings contour data by means of an optical sensor firmly connected to the aircraft; matching the captured hangar interior contour data with hangar interior contour reference data as reference data in order to continuously determine an actual position of the optical sensor relative to the hangar interior contour; comparing the determined actual position with stored sensor target positions in order to detect an aircraft-hangar collision risk. The method according to the invention is substantially associated with the same advantages as the system according to the invention for detecting an aircraft-hangar collision risk.

The object may be further achieved by a method for navigating an aircraft in a hangar, having the method steps of: continuously capturing space contour data of the aircraft surroundings as surroundings contour data by means of an optical sensor firmly connected to the aircraft; matching the captured space contour data with contour data of an aircraft protection zone as reference data; detecting an aircraft-object collision risk if the matching reveals that at least some of the captured space contour data are inside the aircraft protection zone. The method according to the invention is substantially associated with the same advantages as the system according to the invention for detecting an aircraft-object collision risk.

The aspects and further aspects, features and advantages of the invention that are described above can likewise be taken from the examples of the embodiment that is described below with reference to the appended drawings.

### BRIEF DESCRIPTION OF THE DRAWINGS

In the figures, the same reference signs are used for elements, components or aspects that are the same or at least similar. It is noted that there follows a detailed description of embodiments that are merely illustrative and not restrictive. In the claims, the word “having” does not exclude other elements and the indefinite article “a” or “an” does not exclude more than one. The fact alone that certain features are mentioned in various dependent claims does not restrict the subject matter of the invention. Combinations of these features can also be advantageously used. The reference signs in the claims are not intended to restrict the scope of the claims. The figures are not to be understood as true to scale but are only of a schematic and illustrative character. In the figures:

FIG. 1 shows a plan view of a hangar and of an aircraft having a system according to the invention for navigating the aircraft in the hangar according to a first embodiment, wherein the system detects no aircraft-hangar collision risk in the depicted situation,

FIG. 2 shows a plan view of the hangar and the aircraft shown in FIG. 1, wherein the system detects an aircraft-hangar collision risk in the depicted situation,

FIG. 3 shows a plan view of a hangar and of an aircraft having a system according to the invention for navigating the aircraft in the hangar according to a second embodiment, wherein the system detects no aircraft-object collision risk in the depicted situation,

FIG. 4 shows a plan view of the hangar and the aircraft shown in FIG. 3, wherein the system detects an aircraft-object collision risk in the depicted situation,

FIG. 5 shows a plan view of a system for navigating an aircraft in a hangar according to a further embodiment, in which a data processing apparatus is arranged on the aircraft,

FIG. 6 shows a plan view of a system for navigating an aircraft in a hangar according to another embodiment, in which a data processing apparatus is arranged in the hangar,

FIG. 7 shows a schematic depiction of a method according to the invention for navigating an aircraft in a hangar as shown in FIGS. 1 and 2, and

FIG. 8 shows a schematic depiction of a method according to the invention for navigating an aircraft in a hangar as shown in FIGS. 3 and 4.

### DETAILED DESCRIPTION OF THE PREFERRED EMBODIMENTS

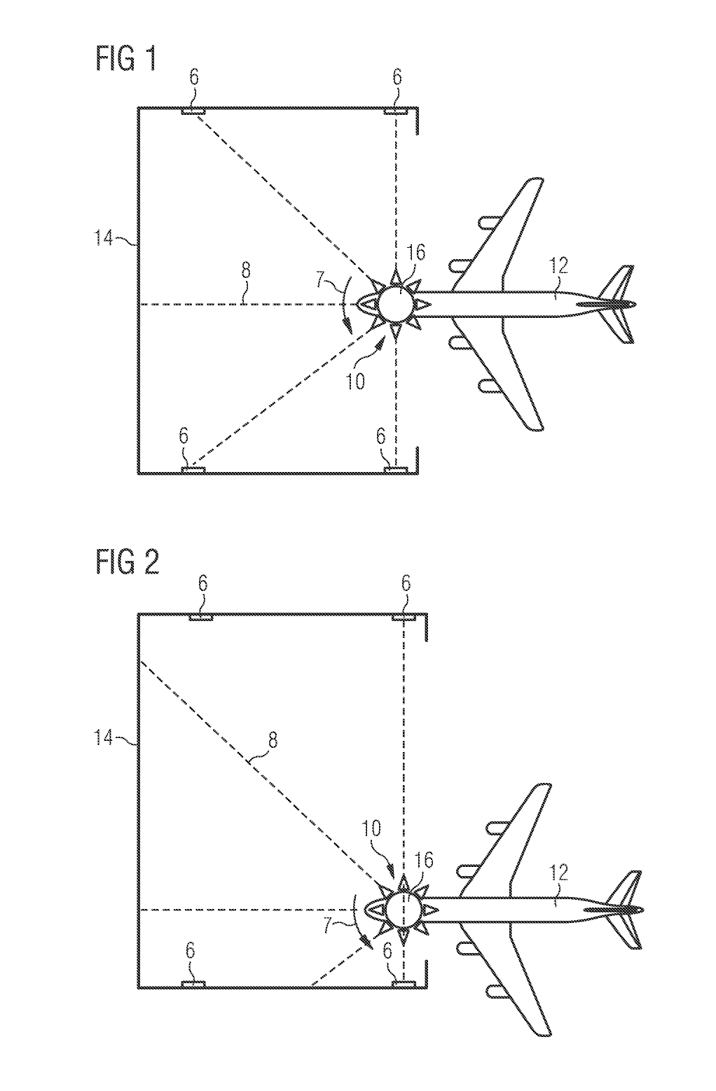

FIG. 1 shows a hangar 14 and an aircraft 12 having a system 10 for navigating the aircraft 12 in the hangar 14. The system 10 is suitable for detecting whether there is a hangar collision risk for the aircraft 12. In a situation depicted in FIG. 1, which can arise when the aircraft 12 is being brought into or taken out of the hangar 14, for example, there is no hangar collision risk, since no point on the aircraft 12 threatens to collide with the hangar 14 or the hangar walls (in particular not in the area of the hangar door edges and the aircraft wings).

The system 10 comprises an optical sensor 16, firmly connected to the aircraft 12, that can be used to continuously capture surroundings contour data relative to the aircraft 12. In FIG. 1, the sensor 16 is configured as a two-dimensional laser scanner that firstly transmits a scanning beam 8 in rotating manner (cf arrow 7) and secondly receives reflections that arise along the hangar interior contour or along reflectors 6 arranged on the hangar inside 14 as a result of the incident scanning beam 8. In this manner, the sensor 16 can capture surroundings contour data relative to the aircraft 12.

FIG. 2 shows the aircraft 12 having the system 10 shown in FIG. 1 in an exemplary situation in which the aircraft 12 is positioned relative to the hangar 14 such that there would be a hangar collision (in the area of the left aircraft engine) in the event of further forward travel into the hangar 14. The system 10 detects an aircraft-hangar collision risk in the depicted situation.

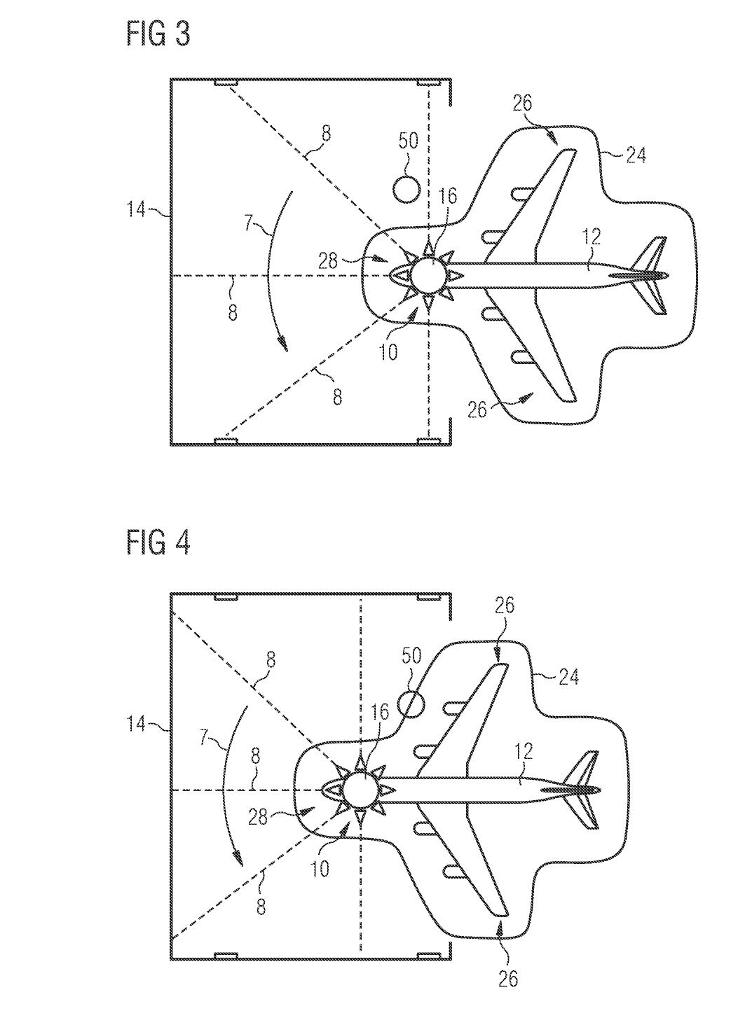

FIG. 3 likewise shows a hangar 14 and an aircraft 12 having a system 10 for navigating the aircraft 12 in the hangar 14. The system 10 is suitable for detecting whether there is an aircraft-object collision risk for the aircraft 12. In the situation depicted in FIG. 3, which can arise when the aircraft 12 is being brought into or taken out of the hangar 14, for example, there is no aircraft-object collision risk, since the object 50 is not inside a virtual aircraft protection zone 24 surrounding the aircraft 12. An object 50 with which an undesirable collision can take place may be a motor vehicle standing in the hangar 14 or another item, for example.

The system 10 comprises inter alia an optical sensor 16, firmly connected to the aircraft 12, that can be used to continuously capture surroundings contour data relative to the aircraft 12. In FIG. 3, the sensor 16 is configured as a two-dimensional laser scanner that firstly transmits a scanning beam 8 in rotating manner (cf. arrow 7) and secondly receives reflections that arise on the object 50 as a result of the incident scanning beam 8. In this manner, the sensor 16 can capture surroundings contour data relative to the aircraft 12. The optical sensor 16 is arranged in the area of the nose gear of the aircraft 12 such that in the extended state of the nose gear the optical sensor is able to see a monitoring area that comprises two lateral aircraft areas 26 and a front aircraft area 28.

FIG. 4 shows the aircraft 12 having the system 10 shown in FIG. 1 in an exemplary situation in which the aircraft 12 is positioned such that an object collision would arise (in the area of the right aircraft wing) in the event of further forward travel into the hangar 14. The system 10 detects an aircraft-object collision risk in the depicted situation, since at least part of the object 50 is inside the aircraft protection zone 24.

FIG. 5 shows those components of a system 10, which, as shown in FIGS. 1 to 4, is suitable for detecting an aircraft-hangar collision risk or an aircraft-object collision risk, that are installed on the aircraft. The system 10 comprises a first optical sensor 16, firmly connected to the aircraft 12, and a second sensor 18, likewise firmly connected to the aircraft 12. The sensors 16, 18 are suitable for continuously capturing surroundings contour data relative to the aircraft 12 and may in particular be configured as optoelectronic sensors or as two-dimensional laser scanners. As such, they can transmit a rotating scanning beam 8 (cf. arrow 7) and receive reflections from surroundings contours, wherein the distance of the reflecting objects are derivable from the propagation time of the reflections and are capturable as surroundings contour data in polar coordinates. The system 10 further comprises a data processing apparatus 20, which is connected to the first and second sensors 16, 18 via data cable 30 and has a data memory 22.

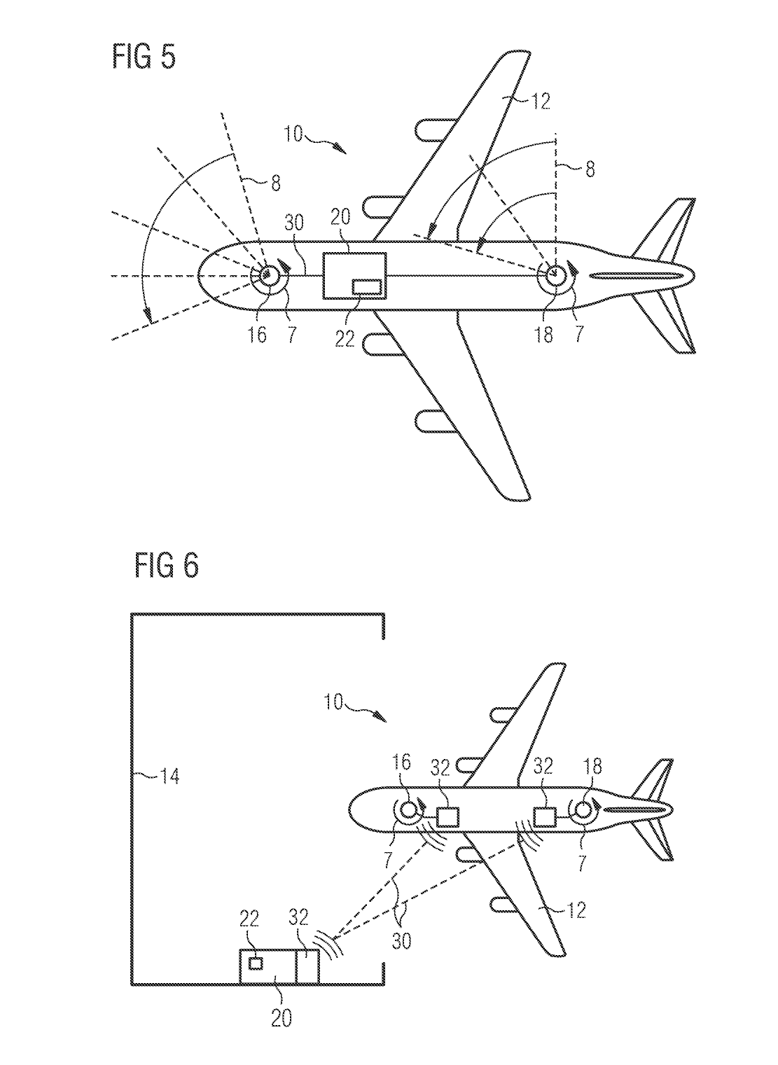

FIG. 6 depicts an alternative embodiment to FIG. 5, in which the data processing apparatus 20 is fitted in a hangar and the data processing apparatus 20 and the optical sensor(s) 16, 18 each have a transmission and reception device 32 for sending and receiving data. As this system 10 dispenses with a data processing apparatus 20 arranged on the aircraft, it is advantageously possible for the weight of said apparatus to be saved on the aircraft. The data processing apparatus 20 fitted in the hangar can communicate with the sensor(s) 16, 18 via a WLAN, for example. The data memory 22 is integrated in the data processing installation 20, for example. The arrows 7 depicted in the area of the two sensors 16, 18 indicate the direction of rotation of the scanning beams 8 of the optoelectronic sensors 16, 18.

In particular in the case of the embodiment of the system 10 that is depicted in FIG. 6, the aircraft may be provided with at least one coupling device, not depicted, that allows the optical sensor(s) 16, 18 along with the corresponding transmission and reception devices 32 to be detachably mounted on the aircraft 12. This means that the sensors 16, 18 and sensor transmission and reception devices 32 can be kept to a certain extent loose from (independent of) the aircraft 12 and connected to the aircraft's coupling device in rotationally fixed manner by workers for the purpose of the navigation in the hangar 14. After navigation has taken plane, the sensors 16, 18 together with the corresponding transmission and reception devices 32 can be removed from the coupling device or the aircraft 12 again. In this manner, no further components of the system 10 need to be permanently provided on the aircraft apart from the coupling device.

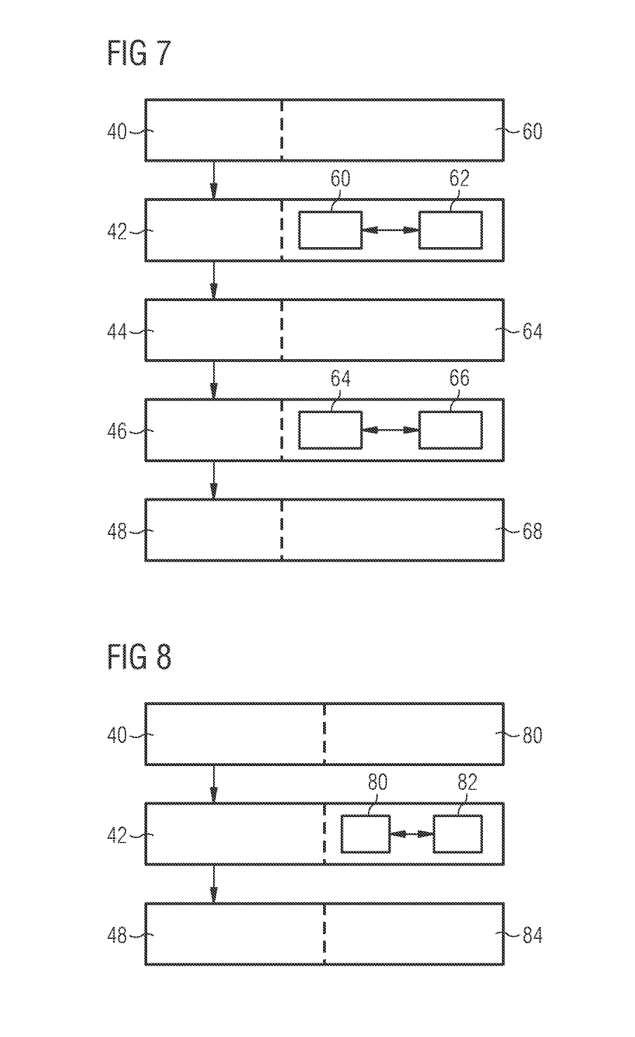

FIG. 7 uses a schematic block diagram to show the basic flow of a method for navigating an aircraft 12 in a hangar 14, as performed by the previously described systems 10 shown in FIGS. 5 and 6. The method allows an aircraft-hangar collision risk 68 to be detected (cf. FIGS. 1 and 2). In a first method step, this involves hangar interior contour data 60 being continuously captured 40 relative to the aircraft 12 as surroundings contour data by means of an optical sensor 16, 18 firmly connected to the aircraft 12. Subsequently, the continuously captured hangar interior contour data 60 are matched 42 with previously known hangar interior contour reference data 62 in order to continuously determine 44 an actual position 64 of the optical sensor 16, 18 relative to the hangar interior contour. Finally, in a last method step, the determined actual position 64 can be compared 46 with likewise stored sensor target positions 66 in order to detect 48 an aircraft-hangar collision risk 68.

FIG. 8 uses a further block diagram to depict the basic flow of an alternative method for navigating an aircraft 12 in a hangar 14. This method can be performed by means of the previously described systems 10 shown in FIGS. 5 and 6 in order to detect an aircraft-object collision risk 84 (cf. FIGS. 3 and 4). In a first method step, the space contour data 80 of the aircraft surroundings are continuously captured 40 as surroundings contour data by means of an optical sensor 16, 18 firmly connected to the aircraft 12. Subsequently, the captured space contour data 80 are matched 42 with contour data 82 of an aircraft protection zone 24. If this matching 42 reveals that at least some of the captured space contour data 80 are inside the aircraft protection zone 24, the aircraft-object collision risk 84 is detected 48.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for navigating an aircraft in a hangar, comprising:
at least one optical sensor firmly connected to the aircraft, wherein the sensor is configured to continuously capture surroundings contour data relative to the aircraft, and
a data processing apparatus, connected to the at least one optical sensor, the data processing apparatus having a data memory storing reference data,
wherein the data processing apparatus is configured to detect an aircraft collision risk by continuously matching captured surroundings contour data with the reference data.

2. The system according to claim 1, wherein the surroundings contour data comprise hangar interior contour data, and wherein the reference data comprise hangar interior contour reference data, and wherein matching thereof allows an actual position of the at least one optical sensor relative to the hangar interior contour to be determined, and wherein comparing the determined actual position with sensor target positions by the data processing apparatus allows an aircraft-hangar collision risk to be detected.

3. The system according to claim 1, wherein the surroundings contour data comprise space contour data of surroundings of the aircraft, and wherein the reference data comprise contour data of a protection zone surrounding the aircraft, wherein an aircraft-object collision risk is detected if the matching reveals that at least some of the captured space contour data is inside the protection zone surrounding the aircraft.

4. The system according to claim 1, wherein the at least one optical sensor is arranged on a nose gear of the aircraft such that in an extended state of the nose gear a monitoring area that comprises a lateral aircraft area and a front aircraft area is visible for the at least one optical sensor.

5. The system according to claim 1, further comprising at least one further optical sensor configured to continuously capture additional surroundings contour data and connected to the data processing apparatus.

6. The system according to claim 1, wherein the at least one optical sensor is configured as an optoelectronic sensor.

7. The system according to claim 1, wherein in that the aircraft is provided with at least one coupling device that is configured to detachably connect the at least one optical sensor to the aircraft.

8. The system according to claim 7, wherein the data processing apparatus is fitted in a hangar and the data processing apparatus and the at least one optical sensor each have a transmission and reception device for sending and receiving surroundings contour data and reference data.

9. A method for navigating an aircraft in a hangar, comprising the steps of:
continuously capturing hangar interior contour data relative to the aircraft as surroundings contour data with an optical sensor firmly connected to the aircraft;
matching the captured hangar interior contour data with hangar interior contour reference data as reference data in order to continuously determine an actual position of the optical sensor relative to the hangar interior contour; and,
comparing the determined actual position with stored sensor target positions in order to detect an aircraft-hangar collision risk.

10. A method for navigating an aircraft in a hangar comprising the steps of:
continuously capturing space contour data of surroundings of the aircraft as surroundings contour data by means of an optical sensor firmly connected to the aircraft;
matching the captured space contour data with contour data of an aircraft protection zone as reference data;
detecting an aircraft-object collision risk if the matching reveals that at least some of the captured space contour data are inside the aircraft protection zone.

11. The system according to claim 6, wherein the optoelectronic sensor comprises a two-dimensional laser scanner.
